(19) United States
(12) Patent Application Publication
(10) Pub. No.: US 2013/0088880 A1
(43) Pub. Date: Apr. 11, 2013

(54) LED LIGHTING DEVICE

(71) Applicants: Qiang-Fei Duan, New Taipei City (TW); Mao-Sheng Liang, New Taipei City (TW)

(72) Inventors: Qiang-Fei Duan, New Taipei City (TW); Mao-Sheng Liang, New Taipei City (TW)

(73) Assignee: COOLER MASTER CO., LTD.

(21) Appl. No.: 13/270,858

(22) Filed: Oct. 11, 2011

(51) Int. Cl. F21V 17/00; F21V 29/00

(52) U.S. Cl. 362/373; 362/375

(57) ABSTRACT

A lighting device includes a seat having a first end and a second end opposite the first side, a top surface being formed at the first end; a light source unit installed on the top surface; and a contact cap connected to the second end. The light source further includes a metal core printed circuit board (MCPCB) having a base portion and a plurality of first extension portions extended from and bent along an edge of the base portion to be embedded in the seat, and at least one light emitting diode (LED) disposed on the base portion. The lighting device has the advantages of light weight, simple manufacturing and excellent heat-dissipating ability

### BACKGROUND OF THE INVENTION

1. Field of the Invention

The present invention relates to a lighting device, and in particular to a light-emitting diode (LED) lighting device having characteristics of light weight, convenience in manufacturing and efficiently heat-dissipating capability.

2. Description of Prior Art

A LED is a semiconductor element, which converts electrical energy to light energy for illumination, with advantages including longer lifetime, greater durability and reliability and lower energy consumption. Earlier LEDs are used for indicators, traffic lights or illuminators for signboards; however while the white light LED comes out, it starts to use the LEDs in applications as diverse as replacements for indoor or outdoor lighting devices.

Please refer to FIG. 1 showing a cross-sectional view of a conventional LED light bulb. The LED lighting device includes a contact cap 90, a heat-dissipating block 91, an aluminum substrate 92, an aluminum plate 93, a circuit board 96, a plurality of LEDs 94, and a cover 95. The heat-dissipating block 91 has a hollow body 911 with two ends connected with the contact cap 90 and the substrate 92, respectively. A plurality of heat-dissipating fins 912 extended from an outer wall of the body 911 are circularly arranged to dissipate heat generated from the light bulb to the environment. The aluminum plate 93 is disposed on the substrate 92, the circuit board 96 is disposed on the plate 93, and the LEDs 94 are disposed on and electrically coupled to the circuit board 96. The circuit board 96 is electrically coupled with the contact cap 90 through two wires 97 and a driving circuit 98 installed in the hollow body 911. The cover 95 then covers on the aluminum substrate 92.

When the LED light bulb is turned on, the heat generated by the LEDs 94 will be conducted from the aluminum substrate 92 through the aluminum plate 93 to the fins 912 of the heat-dissipating block 91 and then to the environment. However, since the circuit board 96 is directly attached on the aluminum plate 93 which in turn is directly attached on the aluminum substrate 92, the circuit board 96 will be inevitably getting hot so that the efficiency the LEDs 94 may be degraded to cause lower brightness, shorter lifetime and wavelength shifting and even the LEDs 94 will be damaged frequently.

### SUMMARY OF THE INVENTION

The present invention is to provide a lighting device with the advantages of light weight, simple manufacturing and excellent heat-dissipating ability.

The lighting device according to the present invention includes a seat having a first end and a second end opposite the first side, a top surface being located at the first end; a light source unit installed on the top surface; and a contact cap connected to the second end. The light source further includes a metal core printed circuit board (MCPCB) having a base portion and a plurality of first extension portions extended from and bent along an edge of the base portion to be embedded in the seat, and at least one light emitting diode (LED) disposed on the base portion.

Accordingly, the lighting device of the present invention utilizes the macromolecular material mixed with the thermal conductive particles to make the plastic seat so that the heat generated by the LED(s) can be efficiently dissipated, which has the advantages of simple manufacturing, light weight, better durable flexibility and excellent insulation. Besides, the MCPCB is bent to have the extension portions embedded in the seat so that the heat generated by the LED(s) will be quickly taken away from the LED(s) to prevent the LED(s) from being degraded to cause lower brightness, shorter lifetime and wavelength shifting and even damage.

### BRIEF DESCRIPTION OF DRAWING

These and other features and advantages of the various embodiments disclosed herein will be better understood with respect to the following description and drawings, in which like numbers refer to like parts throughout, and in which:

FIG. 1 is a cross-sectional view of a conventional LED light bulb.

FIG. 2 is an exploded perspective view of a lighting device according to the present invention.

FIG. 3 is a perspective view of a lighting device according to the present invention.

FIG. 4 is a partially cross-sectional view of a lighting device according to the present invention.

FIG. 5 is an expanded view of a light source unit according to a first preferable embodiment of the present invention.

FIG. 6 and FIG. 7 are an expanded view of the light source unit and an exploded perspective view of the lighting device according to a second preferable embodiment of the present invention, respectively.

FIG. 8 an expanded view of a light source unit according to a third embodiment of the present invention.

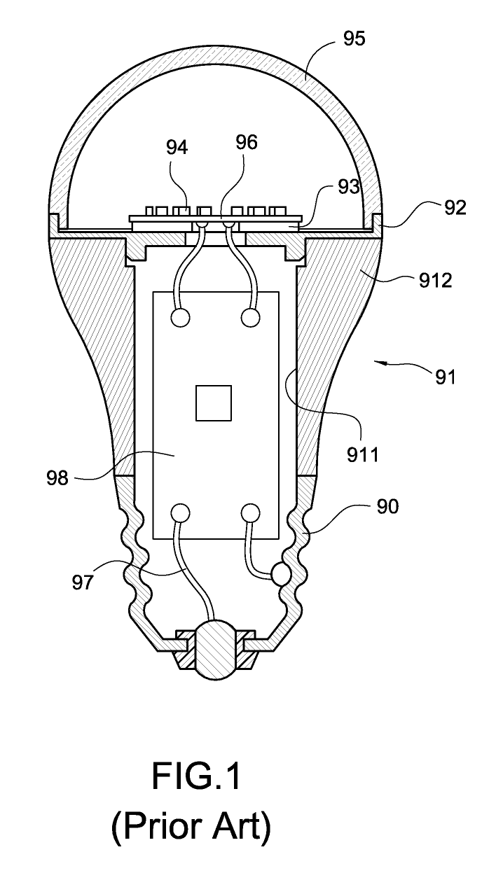

### DETAILED DESCRIPTION OF THE INVENTION

Hereinafter, the present invention will be described in detail with reference to the accompanying drawings. It should be understood that drawings do not limit the scope of the present invention.

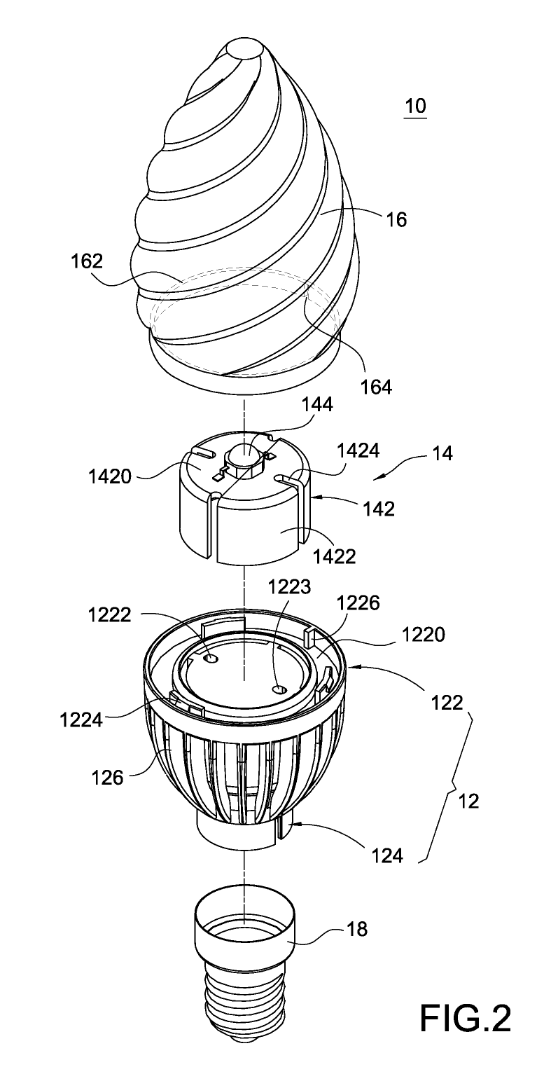

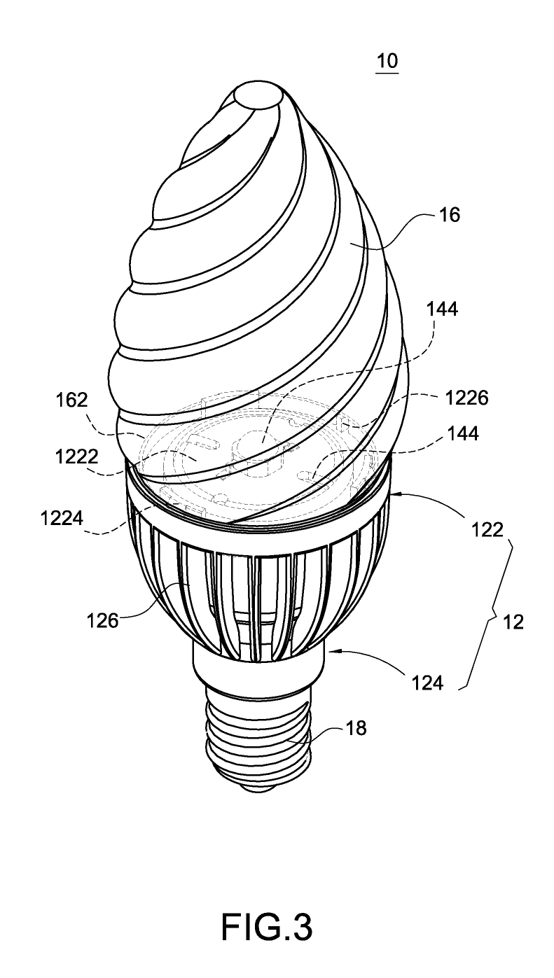

Please refer to FIGS. 2 to 4, which show an exploded perspective view, a perspective view and a partially cross-sectional view of a lighting device according to the present invention. The lighting device 10 includes a plastic seat 12, a light source unit 14, a cover 16 and a contact cap 18. The seat 12 has an integral structure made by mold injection and made of macromolecular material with high thermal conductive coefficient. There are a plurality of thermal conductive particles 120 added in the macromolecular material to increase the thermal conductive coefficient of the seat 12; therefore, heat generated from the light source unit 14 can be rapidly dissipated by the seat 12. Preferably, the thermal conductive particles 120 are selected from metal oxide, graphite and ceramic powders with high thermal conductive coefficient.

The plastic seat 12 have a first end 122 and a second end 124 opposite to the first end 122. In the preferred embodiment, the plastic seat 12 has a cup shape and a diameter of the first end 122 is larger than that of the second end 124. A top surface 1220, which is integrally formed with the seat 12, is located on the first end 122. An accommodating room 1240 is formed between the top surface 1220 and second end 124 inside the seat 12 to receive a power converter module 19. The converter module 19 is used to convert the wall power to the power suitable for the light source unit 14, which preferably includes an AC to DC converter. A central protrusion 1222, a plurality of locking components 1224 and a positioning projection 1226 are formed on the top surface 1220. A plurality of apertures 1223 connected to the accommodating room 124 are formed on the protrusion 1222.

A plurality of heat-dissipating fins 126 with the thermal conductive particles 120 are integrally formed and circularly arranged on an outer wall of the seat 12 so that the dissipating areas are increased and the dissipating effect is enhanced. Thus, the plastic seat 12 with the thermal conductive particles 120 is an excellent heat sink, and has the advantages of light weight and simple manufacturing.

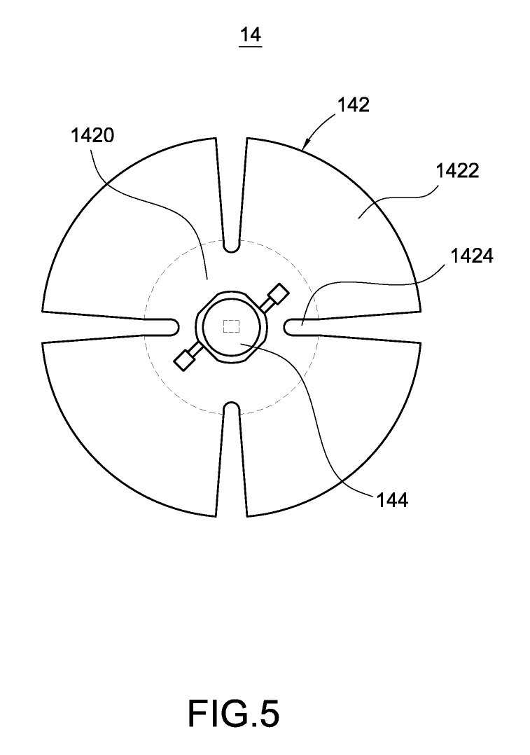

Please refer to FIG. 5 showing an expanded view of a light source unit according to a first preferable embodiment of the present invention. The light source unit 14 is installed on the top surface 1220 and includes a metal core printed circuit board (MCPCB) 142 and at least one LED 144. The MCPCB 142 is pre-formed with a plurality circuit layouts (not shown) and soldering pads, which has a good thermal conductivity to rapidly dissipate the heat generated by the LED 144. The MCPCB 142 includes a base portion 1420 and a plurality of first extension portions 1422 extended from and bent along a circular edge of the base portion 1420. While the base portion 1420 is located on the protrusion 1222, the first extension portions 1422 are embedded in the plastic seat 12. In practice, the MCPCB 142 can be made by a pressing process to form a slot 1424 between two adjacent extension portions 1422, and the extension portions 1422 are then bent substantially perpendicular to the base portion 142. A plurality of wires 192 pass through the slots 1424 and then the apertures 1223 to electrically connect between the MCPCB 142 and the power converter module 19.

The LED 144 is disposed on the MCPCB 142, which is preferably a high power LED disposed on the base portion 1420 and electrically connected to the MCPCB 142. There may be a plurality of LEDs but only one LED 144 for the present embodiment.

In practice, the light source unit 14 is made by pre-embedding the MCPCB 142 in a mold for injection of the plastic seat 12 to directly have the seat 12 formed on the extension portions 1422 so that the connection between the MCPCB 142 and the seat 12 is improved to avoid dismounting due to external force and make the heat generated by the LED 144 more quickly conduct to the seat 12 and dissipate by the fins 126 to the environment. Thereafter, the LED 144 is soldered on the MCPCB 142. On the other hand, the LED 144 can be soldered on the MCPCB 142 before assembling of the MCPCB 142 and the seat 12. Then, the MCPCB 142 with the LED is pre-embedded in the mold for injection of the plastic seat 12 to directly have the seat 12 formed on the extension portions 1422

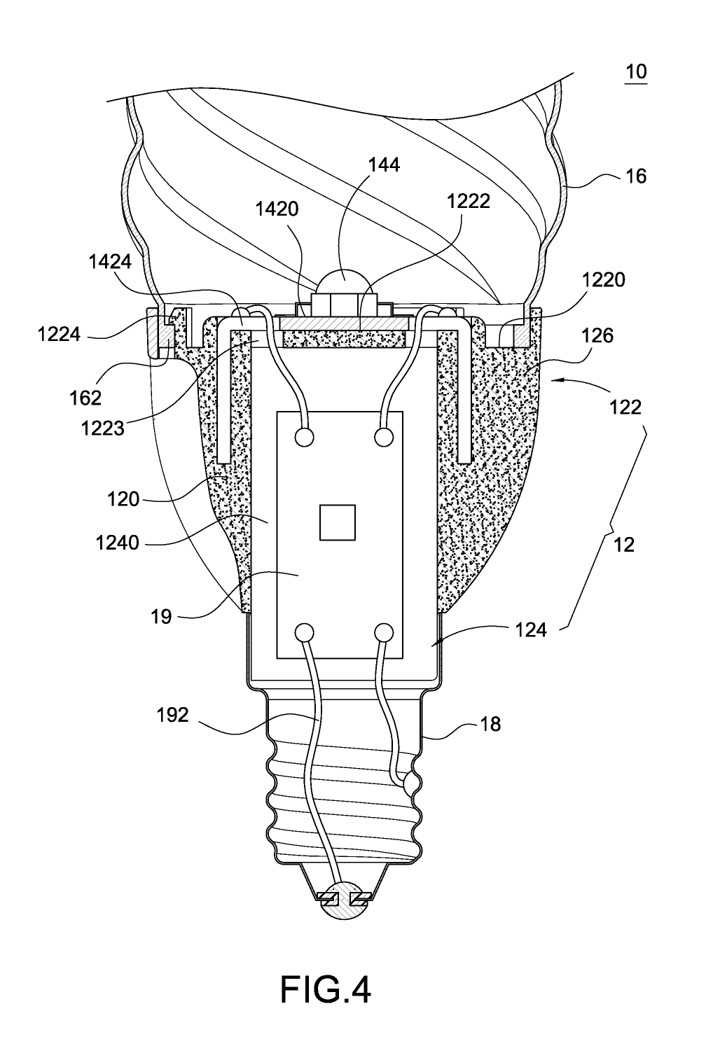

Please refer to FIG. 2 and FIG. 4 again. The cover 16 is connected to the plastic seat 12 to enclose the light source unit 14. In the embodiment, the cover 16 is in a candle shape with a plurality of spiral grooves but not limited thereto. An opening of the cover 16 is formed with a flange 162 for the locking components 1224 to engage thereon while a positioning dent 164 formed on the flange 162 aligns with the positioning projection 1226 to correspondingly receive the projection 1226 therein so that the cover 16 can be fixedly mounted on the seat 12. In practice, a contour of the cover 16 can be in the candle shape or a spherical shape, and the cover 16 can have a transparent, semi-transparent or misty surface for the light passing through according to various demands.

The contact cap 18 is connected to the second end 124 of the plastic seat 12 and electrically coupled to the power converter module 19 through the wires 192. The contact cap 18 can be screwed in a socket to connect the AC power. In the embodiment, the contact cap 18 has an E14 type, for example, but not limited thereto.

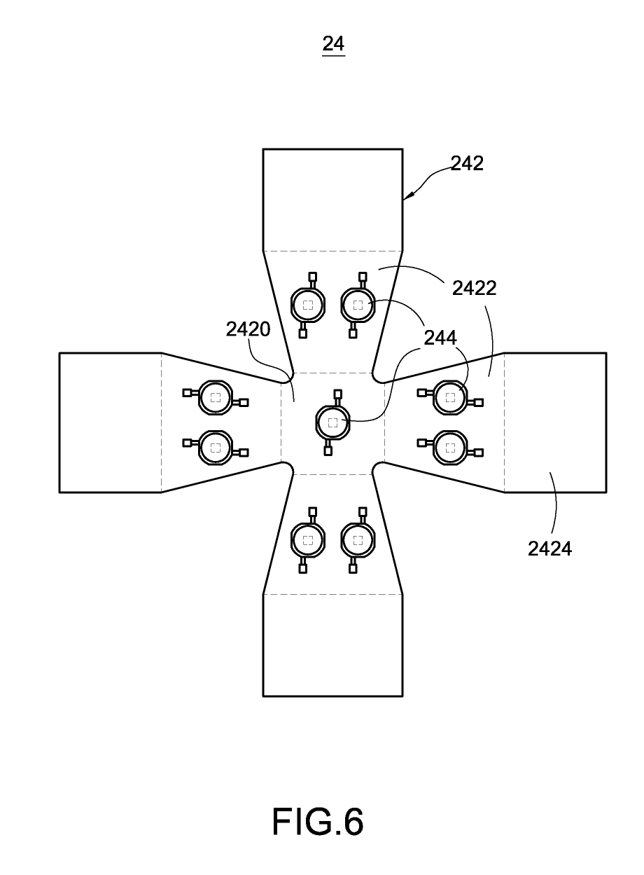

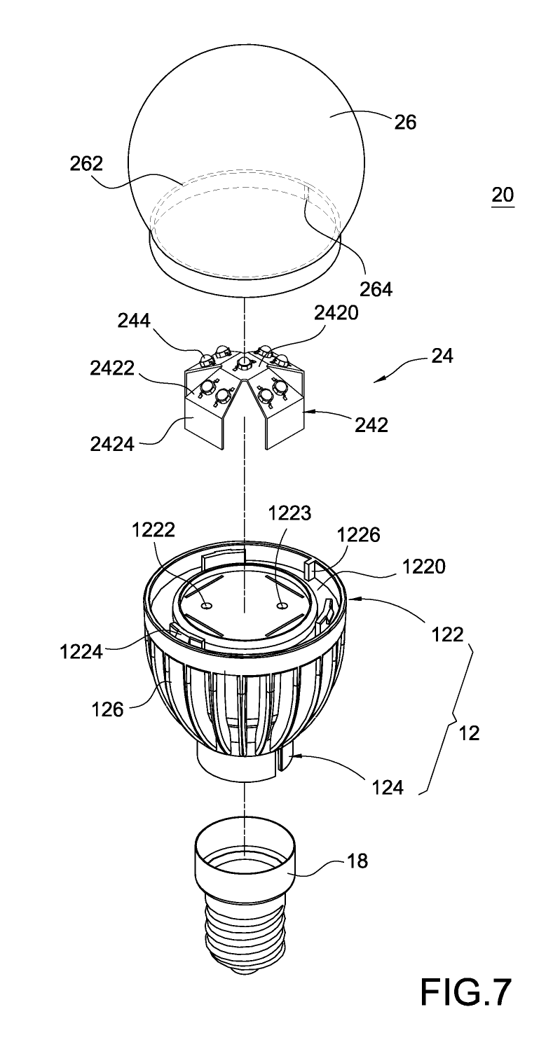

Please refer to FIG. 6 and FIG. 7, which are an expanded view of the light source unit and an exploded perspective view of the lighting device according to a second preferable embodiment of the present invention. The lighting device 20 in the second embodiment is substantially same as the first embodiment except for the light source unit 24 and the cover 26. The light source unit 24 includes a MCPCB 242 and a plurality of LEDs 244. Similarly, the MCPCB 242 is pre-formed with the circuit layouts (not shown) and the soldering pads but includes a base portion 2420, a plurality of first extension portions 2424 and a plurality of second extension portions 2422. The second extension portions 2422 are separately extended from and bent along a rectangular edge of the base portion 2420, the first extension portions 2424 are prolonged and bent from the second extension portions 2422, respectively, and the first extension portions 2424 substantially perpendicular to the base portion 2420 are embedded in the plastic seat 12.

The LEDs 244 are separately disposed on and electrically coupled to the base portion 2420 and the second extension portions 2422. In the embodiment, for example, one LED 244 is disposed on the base portion 2420 and two LEDs 244 are disposed on each extension portion 2422, but not limited thereto. Since the LEDs 244 are disposed on the base portion 2420 and the second extension portions 2422, respectively, the lighting device 20 can provide widely lighting angles.

Similarly, the cover 26 is formed with a flange 262 on an opening and a positioning dent 264. The locking components 1224 of the plastic seat 12 engage on the flange 262 while the positioning dent 264 aligns with the positioning projection 1226 to correspondingly receive the projection 1226 therein so that the cover 26 can be fixedly mounted on the seat 12. In the embodiment, the cover 26 is in a spherical shape but not limited thereto, and the cover 26 can have a transparent, semi-transparent or misty surface for the light passing through according to various demands.

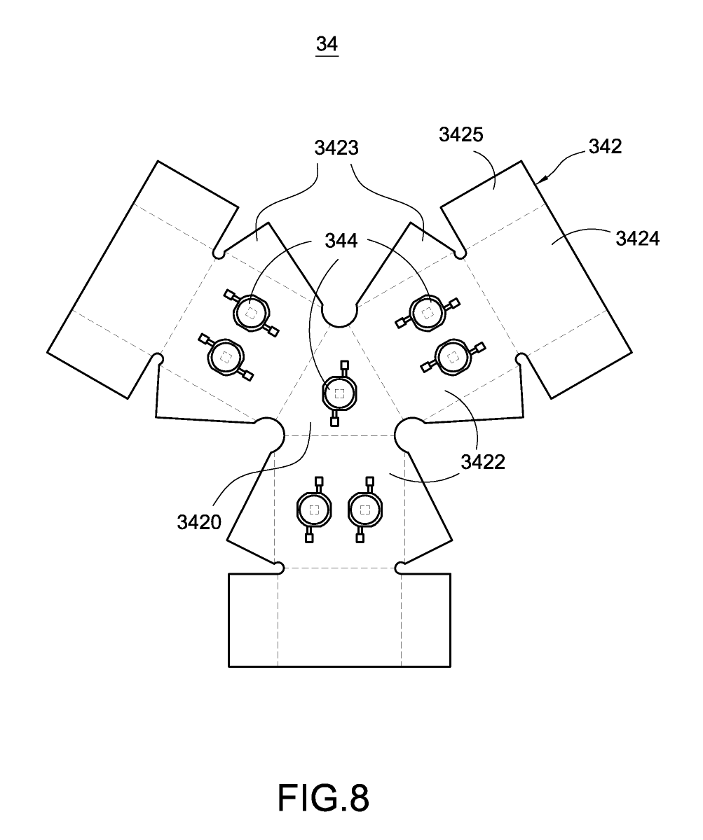

Please refer to FIG. 8 showing an expanded view of a light source unit according to a third embodiment of the present invention. The light source unit 34 includes a MCPCB 342 and a plurality of LEDs 344. Similarly, the MCPCB 342 is pre-formed with the circuit layouts (not shown) and the soldering pads but includes a base portion 3420, a plurality of first extension portions 3424 and a plurality of second extension portions 3422. In the embodiment, the second extension portions 3422 are separately extended from and bent along a triangle edge of the base portion 3420, the first extension portions 3424 are prolonged and bent from the second extension portions 3422, respectively, and the first extension portions 3424 are substantially perpendicular to the base portion 3420. Moreover, the MCPCB 342 includes two first rectangular extension wings 3425 prolonged and bent from two lateral sides of each first extension portion 3424, two second triangle extension wings 3423 prolonged and bent from two lateral sides of each second extension portion 3422, and the first extension portion 3424 and extension wings 3425 are embedded in the plastic seat 12.

The LEDs 344 are separately disposed on and electrically coupled to the base portion 3420 and the second extension portions 3422. In the embodiment, for example, one LED 344 is disposed on the base portion 3420 and two LEDs 344 are disposed on each extension portion 3422.

Accordingly, the lighting device of the present invention utilizes the macromolecular material mixed with the thermal conductive particles to make the plastic seat so as to efficiently dissipate the heat generated by the LED(s), which has the advantages of simple manufacturing, light weight, better durable flexibility and excellent insulation. Besides, the MCPCB is bent to have the extension portions embedded in the plastic seat so that the heat generated by the LED(s) will be quickly taken away from the LED(s) to prevent the LED(s) from being degraded to cause lower brightness, shorter lifetime and wavelength shifting and even damage.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A lighting device comprising:
a seat having a first end and a second end opposite the first side, a top surface being formed at the first end;
a light source unit installed on the top surface and including:
a metal core printed circuit board (MCPCB) having a base portion and a plurality of first extension portions extended from and bent along an edge of the base portion to be embedded in the seat;
at least one light emitting diode (LED) disposed on the base portion; and
a contact cap connected to the second end.

2. The lighting device as recited in claim 1, wherein the seat includes a plurality of high thermal conductive particles.

3. The lighting device as recited in claim 2, wherein the thermal conductive particles are selected from metal oxide, graphite and ceramic powders with high thermal conductive coefficient.

4. The lighting device as recited in claim 1, wherein the seat further includes a plurality of heat-dissipating fins formed on an outer wall thereof

5. The lighting device as recited in claim 1, further comprising a cover connected to the seat to enclose the light source unit

6. The lighting device as recited in claim 5, wherein a plurality of locking components and a positioning projection are formed on the top surface, and an opening of the cover is formed with a flange for the locking components to engage thereon while a positioning dent formed on the flange aligns with the positioning projection to correspondingly receive the projection therein so that the cover is be fixedly mounted on the seat.

7. The lighting device as recited in claim 1, wherein the MCPCB further includes a plurality of second extension portions separately extended and bent from the base portion, the first extension portions are prolonged and bent from the second extension portions, respectively.

8. The lighting device as recited in claim 7, wherein the MCPCB further includes a first extension wing prolonged and bent from each first extension portion, a second extension wing prolonged and bent from each second extension portion.

9. The lighting device as recited in claim 1, wherein a protrusion is formed on the top surface and the base portion are located on the protrusion.

10. The lighting device as recited in claim 1, further comprising a power converter module installed in an accommodating room inside the seat, wherein the accommodating room is formed between the top surface and second end, and the power converter module is connected between the light source unit and the contact cap by a plurality of wires.
